(19) United States
(12) Patent Application Publication
(10) Pub. No.: US 2010/0314816 A1
(43) Pub. Date: Dec. 16, 2010

(54) Clamp

(76) Inventor: Ching-Chen Yang, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/484,210

(22) Filed: Jun. 13, 2009

(51) Int. Cl. B25B 5/06; B25B 7/16

(52) U.S. Cl. 269/214; 269/215

(57) ABSTRACT

A clamp includes two handles pivotally connected to each other, a jaw pivotally connected to a short section of each of the handles and a device for positioning of the handles relative to each other. The positioning device includes a cylinder pivotally connected to a long section of one of the handles, a rack pivotally connected to a long section of the other handle and movably inserted in the cylinder, a detent pivotally connected to the cylinder for engagement with the rack to position the handles relative to each other, a lever comprising a first section pivotally connected to the cylinder and a second section operable to cause the first section of the lever to pivot the detent, and a spring compressed between the cylinder and the second section of the lever, thus tending to cause the first section of the lever to pivot the detent towards the rack.

### BACKGROUND OF INVENTION

1. Field of the Invention

The present invention relates to a clamp and, more particularly, to a clamp with two jaws and a positioning device for retaining the gap between the jaws.

2. Related Prior Art

Vises are often used to hold wood, metal or plastic plates together so that the plates can be processed, e.g., drilled, welded or glued. However, vises are not movable, and it is sometimes inconvenient to use a vise.

To overcome the above-mentioned problem, clamps can be used to hold plates together. It is however difficult for a user to hold plates together firmly with a conventional clamp because he or she has to depend solely on his or her griping force through out the operation. Slacking of the plates could cause injuries to the user or damages to his or her property.

To overcome the foregoing problem, some clamps are equipped with positioning devices for keeping the jaws thereof in position relative to each other. Referring to FIG. 1, a clamp is equipped with a positioning device. Further information about this conventional clamp can be found in U.S. Pat. No. 6,212,977.

Referring to FIG. 2, a clamp includes two handles 10 and 20 pivotally connected to each other with a pin 12, thus dividing the handle 10 into a long section and a short section 15 and dividing the handle 20 into a long section and a short section 25. A jaw 16 is pivotally connected to the short section 15 of the handle 10. A jaw 26 is pivotally connected to the short section 25 of the handle 20. A positioning device 30 is provided between the long sections of the handles 10 and 20. The positioning device 30 includes a rack 31 pivotally connected to the long section of the handle 20 and a cylinder 34 pivotally connected to the long section of the handle 10. The rack 31 is movably inserted in the cylinder 34. A detent 37 is movably located on the cylinder 34. The detent 37 can be engaged with the rack 31 to position the jaws 16 and 26 relative to each other. A lever 36 is pivotally connected to the cylinder 34 with a pin, thus dividing the lever 36 into a long section and a short section. The short section of the lever 36 is connected to the detent 37. A spring is compressed between the long section of the lever 36 and the cylinder 34. Thus, the short section of the lever 36 pushes the detent 37 to engagement with the rack 31. However, the rectilinear movement of the detent 37 could be jammed because of friction between the detent 37 and the cylinder 34. Therefore, the positioning of the jaws 16 and 26 relative to each other could be interfered with. Moreover, it could require a large force from a user to operate the lever 36 to pry the detent 37 from the rack 31.

Therefore, the present invention is intended to obviate or at least alleviate the problems encountered in prior art.

### SUMMARY OF INVENTION

It is the primary objective of the present invention to provide a clamp with a reliable positioning device.

According to the present invention, a clamp includes two handles pivotally connected to each other, a jaw pivotally connected to a short section of each of the handles and a device for positioning of the handles relative to each other. The positioning device includes a cylinder pivotally connected to a long section of one of the handles, a rack pivotally connected to a long section of the other handle and movably inserted in the cylinder, a detent pivotally connected to the cylinder for engagement with the rack to position the handles relative to each other, a lever comprising a first section pivotally connected to the cylinder and a second section operable to cause the first section of the lever to pivot the detent, and a spring compressed between the cylinder and the second section of the lever, thus tending to cause the first section of the lever to pivot the detent towards the rack.

Other objectives, advantages and features of the present invention will become apparent from the following description referring to the attached drawings.

### BRIEF DESCRIPTION OF DRAWINGS

The present invention will be described via detailed illustration of the preferred embodiment versus the prior art referring to the drawings.

FIG. 1 is a perspective view of a conventional clamp including two jaws and a device for positioning the jaws relative to each other.

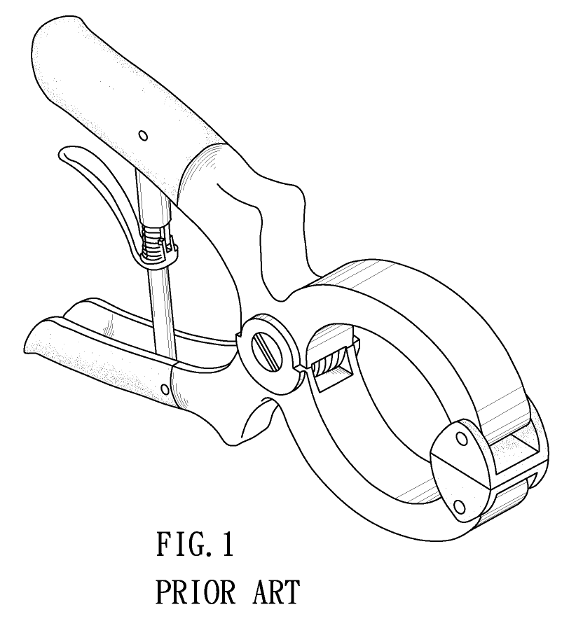

FIG. 2 is a perspective view of another conventional clamp including two jaws and a device for positioning the jaws relative to each other.

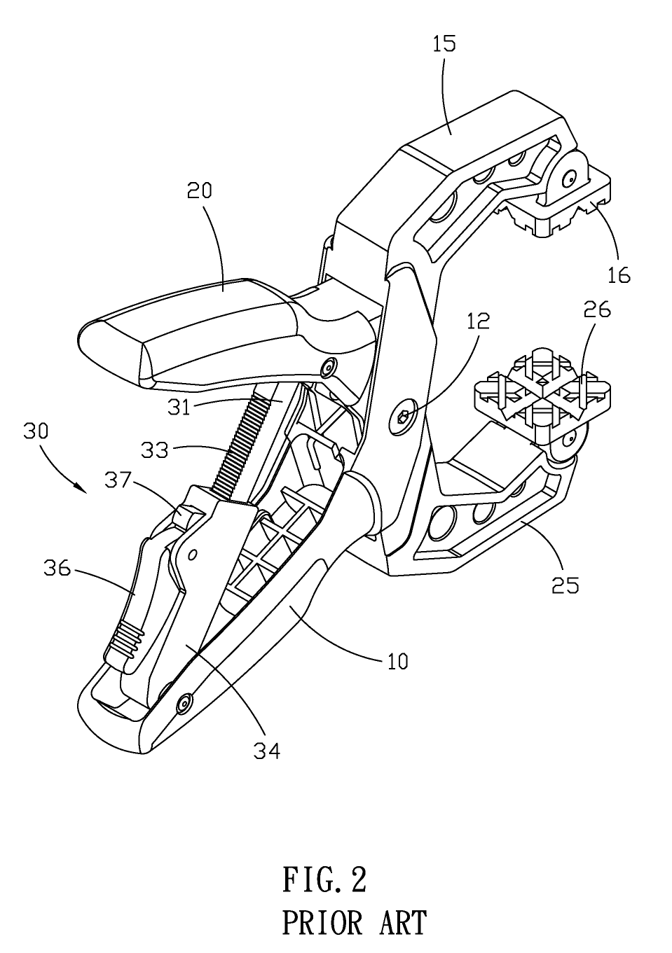

FIG. 3 is a perspective view of a clamp including two jaws and a reliable device for positioning the jaws relative to each other according to the preferred embodiment of the present invention.

FIG. 4 is an exploded view of the clamp shown in FIG. 3

FIG. 5 is a front view of the clamp shown in FIG. 3.

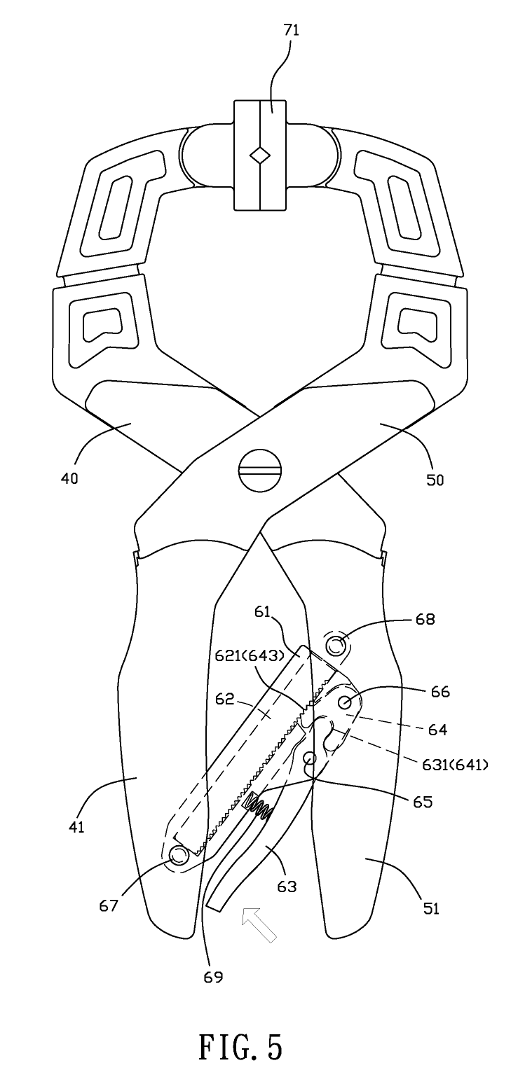

FIG. 6 is a front view of the clamp in another position than shown in FIG. 5.

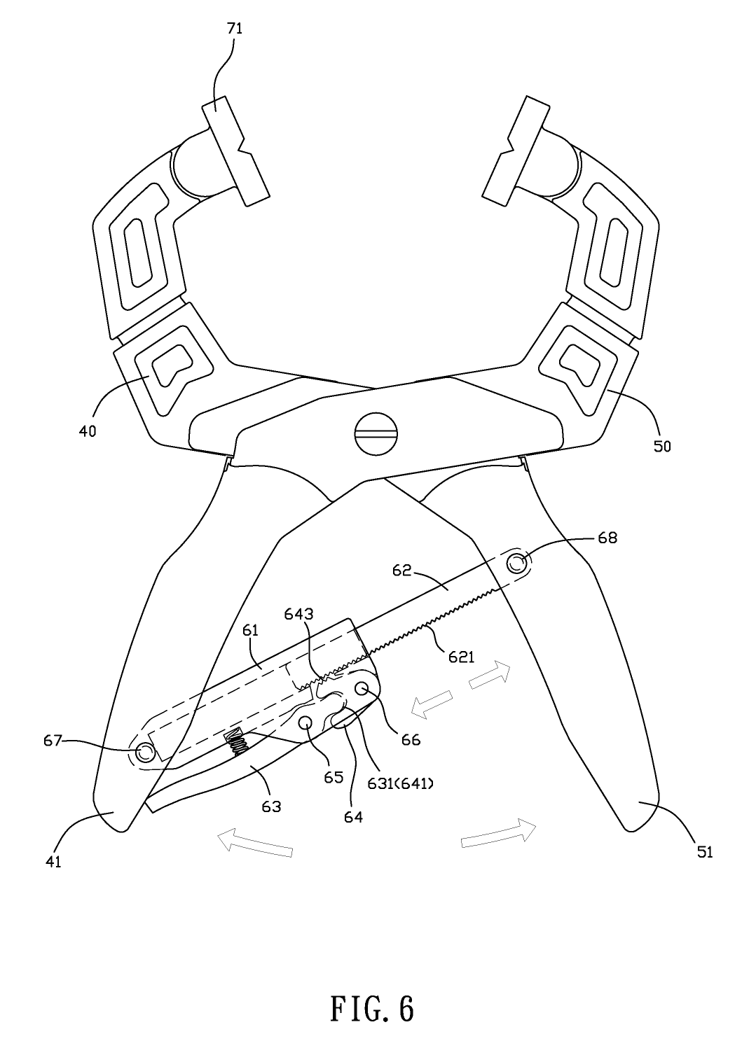

FIG. 7 is a front view of the clamp in another position than shown in FIG. 6.

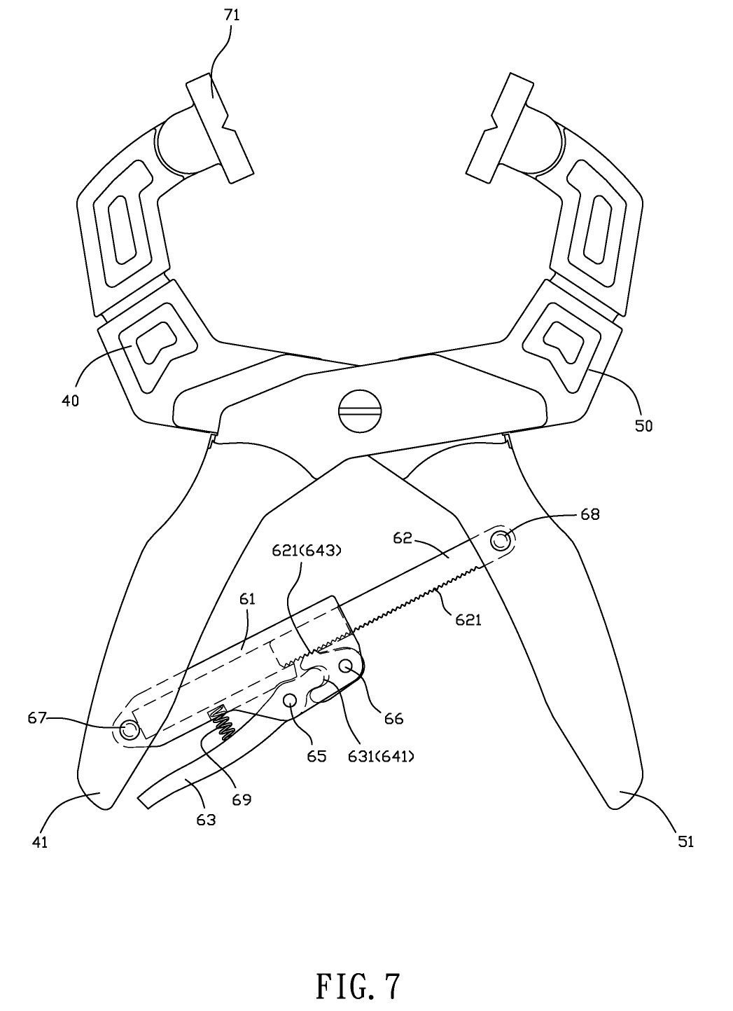

### DETAILED DESCRIPTION OF PREFERRED EMBODIMENT

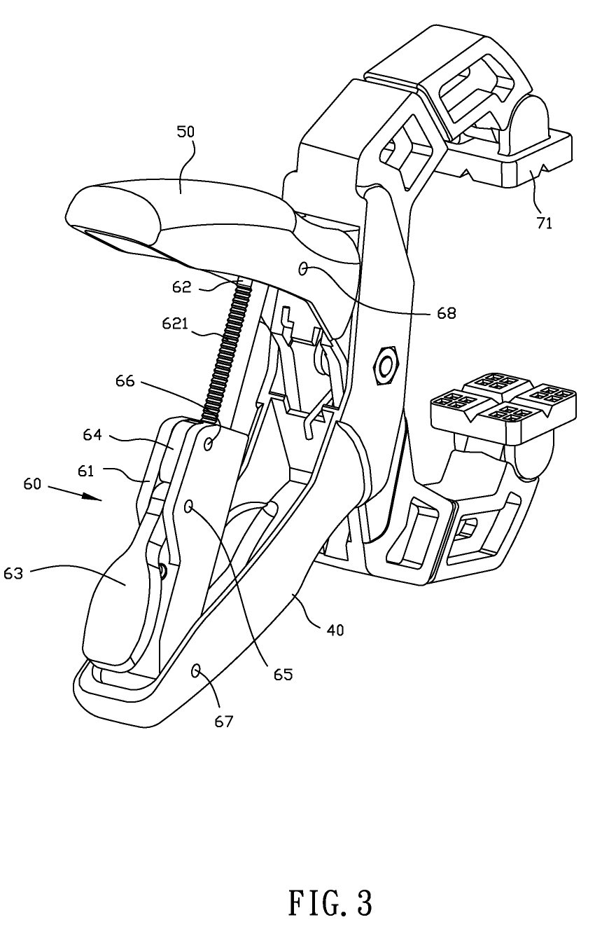

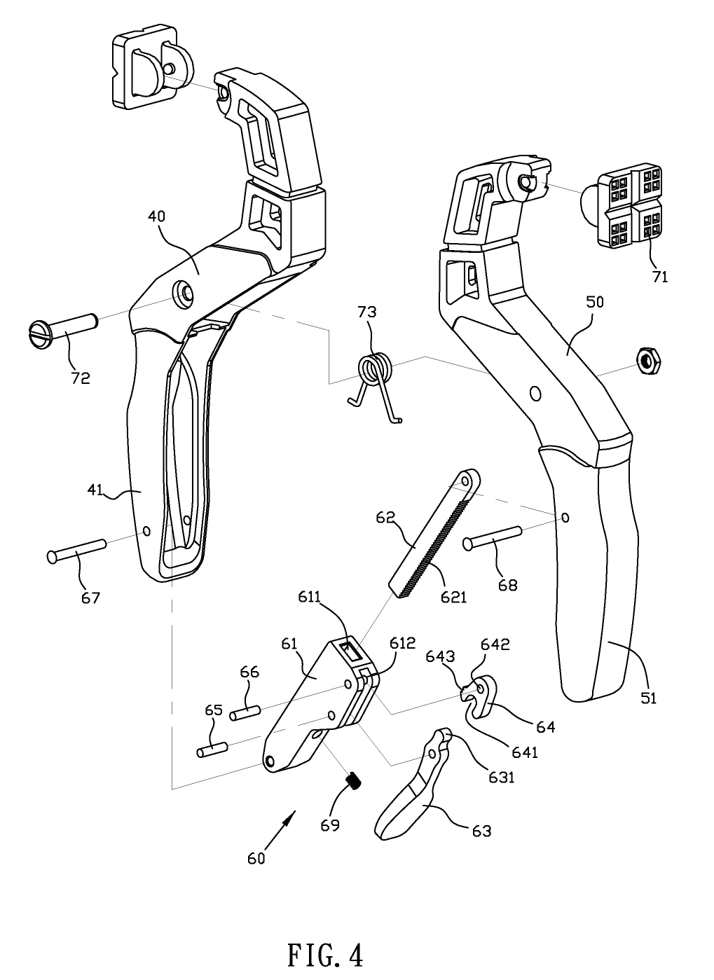

Referring to FIGS. 3 and 4, a clamp includes two handles 40 and 50 and a device 60 for positioning the handles 40 and 50 relative to each other according to the preferred embodiment of the present invention. The handles 40 and 50 are pivotally connected to each other with a threaded bolt 72 thus dividing the handle 40 into a long section 41 and a short section and dividing the handle 50 into a long section 51 and a short section. A torque spring 73 is provided on the threaded bolt 72 and between the long sections 41 and 51 of the handles 40 and 50 so that the torque spring 73 tends to open the handles 40 and 50. A jaw 71 is pivotally connected to the short section of each of the handles 40 and 50.

The positioning device 60 includes a cylinder 61, a rack 62, a detent 64, a lever 63 and a compression spring 69. The cylinder 61 is pivotally connected to the long section 41 of the handle 40 with a pin 67. The cylinder 61 includes a tunnel 611 defined therein and two ears 612 formed thereon.

The rack 62 is of course formed with teeth 621. The rack 62 is pivotally connected to the long section 51 of the handle 50 with a pin 68. The rack 62 is movably inserted in the tunnel 611 of the cylinder 61.

The detent 64 is substantially A-shaped, and includes a recess 641 defined therein, an aperture 642 defined therein and at least one tooth 643 formed thereon. The detent 64 is pivotally connected to the cylinder 61 with a pin 66 driven in the aperture 642 of the detent 64 and an aperture defined in each of the ears 612. The tooth 643 of the detent 64 can be engaged with the teeth 621 of the rack 62, thus positioning the handles 40 and 50 relative to each other.

The lever 63 is pivotally connected to the ears 612 of the cylinder 61 with a pin 65, thus dividing the lever 63 into a long section and a short section. The short section of the lever 63 is formed with a tip 631 inserted in the recess 641 of the detent 64, thus connecting the lever 63 to the detent 64.

The compression spring 69 is compressed between the long section of the lever 63 and the cylinder 61, thus causing the short section of the lever 63 to pivot the detent 64 to engagement with the rack 62. Preferably, each of the cylinder 61 and the lever 63 includes a bore for receiving an end of the compression spring 69.

Advantageously, the pivotal of the detent 64 on the cylinder 61 is smooth so that the positioning of the jaws 40 and 50 relative to each other would not be interfered with. Furthermore, a large force is not required from a user to operate the lever 63 to pry the detent 64 from the rack 62.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A clamp comprising:
two handles pivotally connected to each other with a fastener, thus dividing each of the handles into a long section and a short section;
a jaw pivotally connected to the short section of each of the handles;
a device for positioning of the handles relative to each other, the positioning device comprising:
a cylinder pivotally connected to the long section of one of the handles;
a rack pivotally connected to the long section of the other handle and movably inserted in the cylinder;
a detent pivotally connected to the cylinder for engagement with the rack to position the handles relative to each other;
a lever comprising a first section pivotally connected to the cylinder and a second section operable to cause the first section of the lever to pivot the detent; and
a spring compressed between the cylinder and the second section of the lever, thus tending to cause the first section of the lever to pivot the detent towards the rack.

2. The clamp according to claim 1, wherein the detent comprises an aperture for receiving a pin driven in the cylinder.

3. The clamp according to claim 1, wherein the detent comprises at least one tooth for engagement with teeth formed on the rack.

4. The clamp according to claim 1, wherein the detent comprises a recess for receiving the first section of the lever.

5. The clamp according to claim 1, wherein the detent comprises two ears formed thereon, and the positioning devices comprises a pin driven in the ears and the detent.

6. The clamp according to claim 1, wherein the detent comprises two ears formed thereon, and the positioning devices comprises a pin driven in the ears and the lever.
